(19) United States
(12) Patent Application Publication
(10) Pub. No.: US 2026/0350374 A1
(43) Pub. Date: Nov. 5, 2026

(54) METHOD AND APPARATUS FOR SHIFTED QUANTIZATION FOR ENABLING QUANTIZED EXECUTION OF ATTENTION OPERATION

(71) Applicant: Microsoft Technology Licensing, LLC, Redmond, WA (US)

(72) Inventors: Vedula Venkata Srikant BHARADWAJ, Bellevue, WA (US); Saravanakumar RAJMOHAN, Redmond, WA (US); Victor Jonas RÜHLE, Trumpington (GB); Hao KANG, Atlanta, GA (US)

(73) Assignee: Microsoft Technology Licensing, LLC, Redmond, WA (US)

(21) Appl. No.: 19/194,477

(22) Filed: Apr. 30, 2025

(51) Int. Cl. G06N 3/0495; G06F 16/3329; G06F 17/16; G06N 3/0475; G06N 3/048

(52) U.S. Cl. CPC G06N 3/0495; G06F 16/3329; G06F 17/16; G06N 3/0475; G06N 3/048

(57) ABSTRACT

A data processing system implements analyzing a textual input using an LLM to generate a query data matrix and a key data matrix; quantizing the query data matrix and the key data matrix using a quantization framework to generate a quantized query data matrix and a quantized key data matrix. Each channel in the query data matrix is associated with a channel-specific zero point value and each channel in the key data matrix is associated with a channel-specific zero point value. The system further implements providing the quantized matrices as an input to an attention mechanism of the LLM; analyzing the quantized matrices using the attention mechanism to determine attention scores without dequantizing data of the quantized matrices; and analyzing the attention scores using a softmax operation to generate a probability distribution that represents an attention weight associated with each key of the quantized key data matrix.

### BACKGROUND

Attention mechanisms improve the performance of artificial intelligence (AI) models by focusing the model on relevant information. Attention mechanisms perform a number of operations that are computationally intensive. Attempts to reduce these computational requirements have been made through quantization. Quantization can hep accelerate inference as well as reduce computational, memory, power, and water requirements associated with operating AI models. Quantization maps values to a smaller set of discrete finite values and can take into account the targeted hardware on which these operations using these data values are to be performed. For instance, many operations are performed by attention mechanisms are performed in a 32-bit floating point (FP32) data format. The FP32 data can be quantized to a 8-bit integer (INT8) data format to significantly reduce the computational, memory, power, and water requirements associated with implementing and operating the attention mechanism. Furthermore, the quantized model may be deployed to computing environments having smaller memory footprints and/or having less computing power than would otherwise be required to operate the non-quantized model.

Quantization can lead to faster inference, reduced model size, fewer computational resources required to operate the model, as well reducing power and/or water requirements required to support the hardware on which the model operates. Current quantization methods are unsuitable for use in attention mechanisms because they can introduce significant errors that degrade performance of the model. Hence, there is a need for improved systems and methods for quantizing data in an AI model to facilitate attention mechanisms.

### SUMMARY

An example data processing system according to the disclosure includes a processor and a memory storing executable instructions. The instructions when executed cause the processor alone or in combination with other processors to perform operations including analyzing a textual input using one or more layers of a large language model to generate a query data matrix and a key data matrix; quantizing the query data matrix and the key data matrix using a quantization framework of the large language model to convert floating point values of the query data matrix and the key data matrix to integer values to generate a quantized query data matrix and a quantized key data matrix, wherein each channel in the query data matrix is associated with a channel-specific zero point value and each channel in the key data matrix is associated with a channel-specific zero point value; providing the quantized query data matrix and the quantized key data matrix as an input to an attention mechanism of the large language model; analyzing the quantized query data matrix and the quantized key data matrix using the attention mechanism to determine attention scores without dequantizing data of the quantized query data matrix and data of the quantized key data matrix; and analyzing the attention scores using a softmax operation to generate a probability distribution that represents an attention weight associated with each key of the quantized key data matrix.

An example method implemented in a data processing system includes analyzing a textual input using one or more layers of a large language model to generate a query data matrix and a key data matrix; quantizing the query data matrix and the key data matrix using a quantization framework of the large language model to convert floating point values of the query data matrix and the key data matrix to integer values to generate a quantized query data matrix and a quantized key data matrix, wherein each channel in the query data matrix is associated with a channel-specific zero point value and each channel in the key data matrix is associated with a channel-specific zero point value; providing the quantized query data matrix and the quantized key data matrix as an input to an attention mechanism of the large language model; analyzing the quantized query data matrix and the quantized key data matrix using the attention mechanism to determine attention scores without dequantizing data of the quantized query data matrix and data of the quantized key data matrix; and analyzing the attention scores using a softmax operation to generate a probability distribution that represents an attention weight associated with each key of the quantized key data matrix.

An example machine-readable medium on which are stored instructions that, when executed, cause a processor of alone or in combination with other processors to perform operations of analyzing a textual input using one or more layers of a large language model to generate a query data matrix and a key data matrix; quantizing the query data matrix and the key data matrix using a quantization framework of the large language model to convert floating point values of the query data matrix and the key data matrix to integer values to generate a quantized query data matrix and a quantized key data matrix, wherein each channel in the query data matrix is associated with a channel-specific zero point value and each channel in the key data matrix is associated with a channel-specific zero point value; providing the quantized query data matrix and the quantized key data matrix as an input to an attention mechanism of the large language model; analyzing the quantized query data matrix and the quantized key data matrix using the attention mechanism to determine attention scores without dequantizing data of the quantized query data matrix and data of the quantized key data matrix; and analyzing the attention scores using a softmax operation to generate a probability distribution that represents an attention weight associated with each key of the quantized key data matrix.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A is a diagram of an example of two data formats that can be used by the quantization framework according to the disclosure herein.

FIG. 1B is a diagram of an example asymmetric quantization from a FP32 to INT8 format according to the disclosure herein.

FIG. 1C is a diagram of an example asymmetric quantization from the FP32 to the INT8 format utilizing the quantization framework according to the disclosure herein.

FIG. 1D is a diagram that provides a comparison of a matrix multiplication operation that is performed using the conventional zero point approach that utilizes a single zero point for each of the input matrices and an example of a matrix multiplication operation performed according to the quantization techniques provided herein.

FIG. 2 is a diagram of an example implementation of a quantization framework according to the disclosure herein.

FIG. 3A is a diagram of an example quantization pipeline of the quantization framework of FIG. 2.

FIG. 3B is a diagram of an example quantization pipeline of the dequantization framework of FIG. 2.

FIG. 4A is a diagram of an example of a single dot product attention mechanism that can utilize the quantization framework disclosed herein.

FIG. 4B is a diagram of an example of a multi-head attention mechanism that can utilize the quantization framework disclosed herein.

FIG. 4C is an example architecture of a transformer artificial intelligence model that can utilize the attention mechanisms that incorporate the quantization framework disclosed herein.

FIG. 5 is a diagram of an example computing environment in which the softmax approximation framework is implemented.

FIG. 6 is a flow chart of an example process for quantizing data in an attention mechanism of an AI model according to the techniques disclosed herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

Systems and methods for a quantization framework that enhances the speed and throughput of self-attention mechanisms utilized by large language models are provided. The quantization framework provides a technical solution to the technical problems associated with current self-attention mechanisms which typically perform operations on floating point data. However, performing these calculations on floating point data can introduce significant latency into the self-attention mechanism that can negatively impact the performance of the language model, because the architecture of the graphics processing units (GPUs) on which the language model is implemented can introduce significant bottlenecks that contribute the latency introduced by self-attention mechanism. For instance, exponentiation operations are implemented on slower FP32 cores rather than the more efficient tensor cores which are configured to efficiently handle matrix operations. Consequently, quantized data must be dequantized prior to inference, resulting in conversions between data types that adds additional latency to the self-attention mechanism.

The quantization framework disclosed herein provides a technical solution to these technical problems. The quantization framework enables the execution of operations on the quantized data and does not require that the data be dequantized during inference. Another technical benefit of the quantization framework is that the framework effectively handles outlier channels in the query and key components, which are critical to maintaining the overall performance of the model. A channel represents a specific feature or aspect of the data being processed. Outlier channels are feature dimensions whose values are orders of magnitude higher than the values of other channels. Current approaches to quantization use a shared zero point and scale across all channels, which can result in loss of precision in critical areas of the model. Fine-grained group quantization methods mitigate this issue by allowing different zero points and scales for each group of channels but these methods typically require decompression before inference, which adds complexity and latency. The shifted quantization framework provides a solution to this problem by allowing different minimal values on different groups of channels, ensuing that the precision required for each channel is adequately maintained, without the need for a decompression step prior to inference. The ability to bypass dequantization and perform inference in the self-attention mechanism using the quantized values simplifies the inference process and provides a significant reduction in memory usage and computation bandwidth. These and other technical benefits of the techniques disclosed herein will be evident from the discussion of the example implementations that follow.

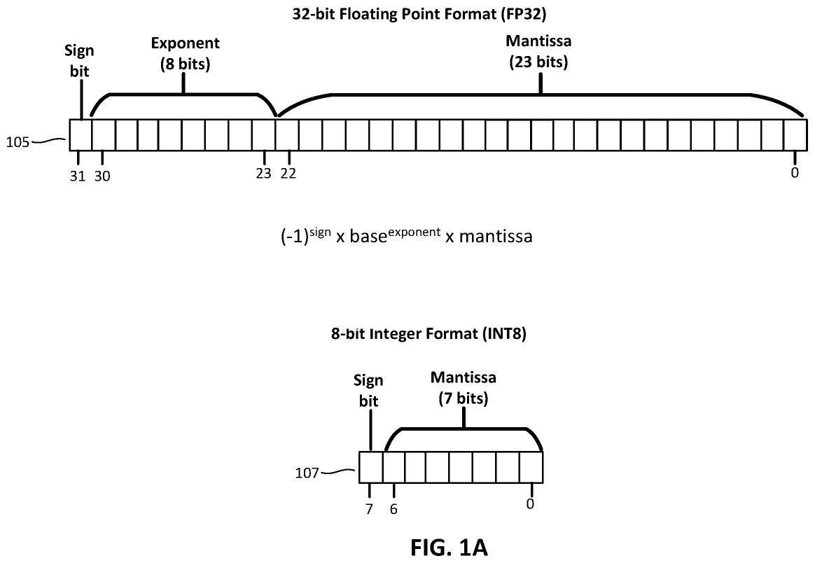

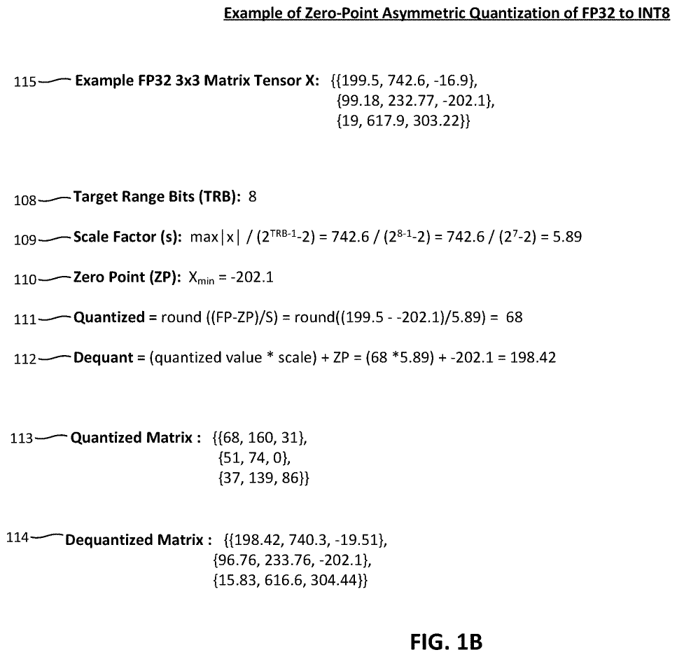

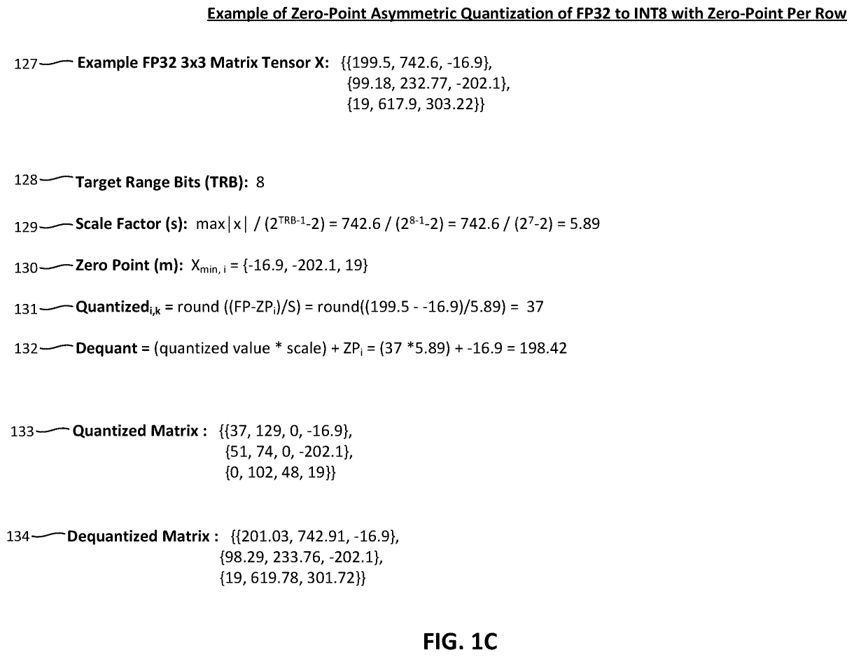

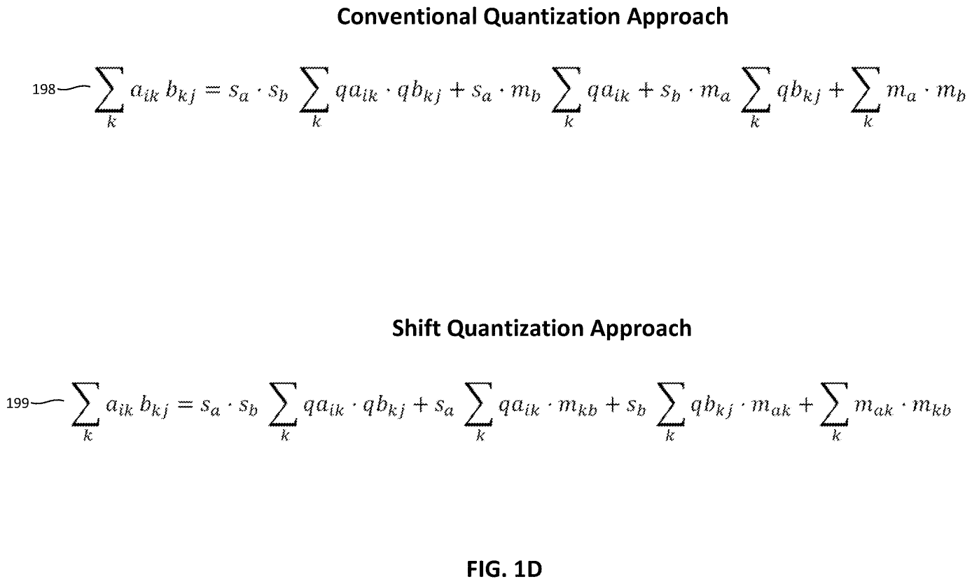

FIGS. 1A-1C are diagrams that provide an example of the quantization framework being used to quantize FP32 data to INT8 data. While these specific examples relate to quantization of FP32 to INT8 data, the quantization framework is not limited to these specific data format. In other implementations, the data to be quantized can be in other source data formats and be quantized to other target data formats. The bit layout 105 shows the bits that comprise FP32 format. The bit layout 107 shows the bit layout of the IN8 format.

FIG. 1B shows an example of asymmetric quantization of FP32 data to INT8 data. Asymmetric quantization involves mapping the minimum and maximum range of the source data format to the target data format using a scale factor and a zero point. The scale value is used to map the range of values in the unquantized source data format to the smaller range of values in the target data format. The zero point is the quantized value in the target data format that corresponds to the value of zero in the unquantized data in the source data format. The examples which follow show how the quantization framework determines the scaling factor and the zero point for the quantization operation.

In the example shown in FIG. 1B, an input matrix 115 of floating point values in FP32 format is quantized to INT8 format. The quantization framework can receive an input matrix to be quantized as well as in indication of the source data format and the target data format. The input matrix may be a matrix of floating point values determined by a large language model. For instance, the input matrix may be a key matrix or value matrix, and the quantization framework is implemented in an attention mechanism of an AI model. An attention mechanism improves the performance of AI models by focusing the model on relevant information. The attention mechanism determines attention weights, which are numerical values that quantify the relevance of elements in an input to the model. A higher attention weight indicates a higher relevance, while a lower attention weight indicates a lower relevance. The model uses these weights to selectively focus on more relevant elements of the input while focusing less or ignoring less elements of the input. The attention mechanism determines the attention weights based on query and key matrices that are determined by other elements of the model and provided as input to the attention mechanism. The alignment between values of the query matrices and key matrices are used to compute the attention weights that are output by the attention mechanism. The query matrix is a matrix of numerical values generated from the embeddings of a current input token being processed by the attention mechanism. The key matrix is a matrix of numerical values that are generated from all of the input tokens. The quantization framework disclosed herein quantizes the floating point values included in the key and value matrices to reduce the computational complexity and latency associated with performing inference on these inputs by quantizing the values included in these matrices. The attention mechanism can provide the key and query matrices as inputs to the quantization framework provided herein to obtain quantized versions of the matrices.

The input matrix 115 includes three rows and three columns to illustrate the concepts disclosed herein. Each row in the example input matrix 115 is associated with a specific channel or feature. However, the input matrix 115 can be oriented such that each column of the matrix is associated with a specific channel or feature. Furthermore, the number of columns and rows included in the input matrix 115 are not limited to three rows and three columns as shown in FIG. 1B. The size of the input matrix 115 was limited in this example to more clearly illustrate the concepts disclosed herein. The input matrix 115 may include significantly more rows and/or columns in implementations in which the quantization framework is implemented in an attention mechanism of an AI model. For instance, the input matrix may be a query matrix, or a key matrix received as an input by the attention mechanism, and the key and query matrices may include a large number of rows and/or columns depending in part upon the complexity of the input being processed by the AI model.

Referring once again to FIG. 1B, the quantization framework determines a number of bits in the target data format, referred to herein as the target range bits 108. The INT8 format includes 8 bits. Therefore, the target range bits 108 in this example is 8.

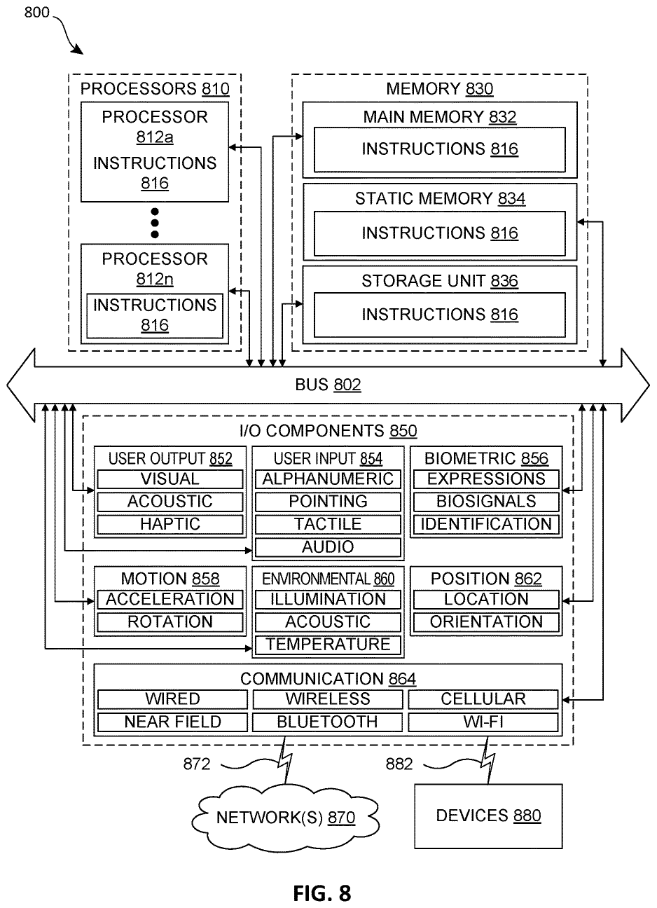

The quantization framework determines a scale factor 109 which is used to convert values in the source data format to the target data format. The scale factor 109 can be expressed as equation (1) below:

$$s = \frac{max \vert X \vert}{{2}^{TRB - 1} - 2} \qquad ( 1 )$$

where s refers to the scale factor, X refers to the input matrix to be quantized, max |x| refers to the maximum value in the input matrix X, and TRB refers to the target range bits. In the example shown in FIG. 8, the maximum value in the input matrix 115 is 742.6, and the scale factor is 5.89.

The quantization framework also determines a zero point (ZP) value for the entire input matrix. In the approach shown in FIG. 1B, the quantization framework determines a single ZP value for the entire input matrix. The ZP value is the minimum value (Xₘᵢₙ) from the input matrix, which has a value of −202.1 in this example.

The quantization framework determines a quantized value for each of the elements of the input matrix 115 using the equation (2) shown below:

$${X}_{q , ik} = round ( \frac{{X}_{ik} * ZP}{s} ) \qquad ( 2 )$$

where X_{q,ij} represents the quantized value in row i and column j of the quantized matrix X_{q} (shown as quantized matrix 113 in FIG. 1B), the round function rounds the floating point value to the nearest integer value, Xᵢⱼ represents the floating point value in row i and column j of the input matrix 115, ZP represents the zero point value, and s represents the scaling factor. The quantized matrix 113 can be provided as an input to one or more components of an attention mechanism of an AI model to enable the model to perform inference on quantized data.

The quantization framework determines a dequantized value for each of the elements of a quantized matrix, such as but not limited to the quantized matrix 113, using equation (3) below:

$${X}_{d , ik} = ( {X}_{q , ik} xs ) + FP \qquad ( 3 )$$

where X_{q,ik} represents the quantized value in row i and column k of the quantized matrix X_{q} (shown as quantized matrix 113 in FIG. 1B), X_{d,ik} represents the floating point value in row i and column k of the dequantized matrix X_{d} (shown as dequantized matrix 114 in FIG. 1B), ZP represents the zero point value, and s represents the scaling factor. As can be seen in FIG. 1B, the values of the dequantized matrix 114 do not exactly match those of the input matrix 115 due to the loss in precision resulting from converting the values from the input matrix 115 from the FP32 data format to the quantized INT8 values of the quantized matrix 113.

FIG. 1C is a diagram of another approach to quantization in which the quantization framework determines a separate zero point value for each channel of the data included in the input matrix. This approach can significantly improve the performance of the attention mechanism in instances in which the query and/or key matrixes include outlier channels. Outlier channels can include feature dimensions which are orders of magnitude higher than the values of other channels. Using a shared zero point across all channels in such situations can introduce significant inaccuracies into the quantized calculations performed by the attention mechanism. Therefore, the quantization framework calculates a zero point for each row or column of the input matrix 115, depending upon whether the row or columns of the input matrix represent different channels in the input data. In the example shown in FIG. 1C, each row represents a different channel, and a row-specific zero point is determined for each row.

The input matrix 127 shown in FIG. 1C is the same as the input matrix 115 shown in FIG. 1B. The TBB 128 is the same as the target range bits 108 shown in FIG. 1B, because the target quantization is also INT8. Consequently, the scale factor 129 is the same as the scale factor 109 shown in FIG. 1B. However, the zero point 130 is calculated for each row of the input matrix 127 in contrast with the zero point 110 shown in FIG. 1B. The quantization framework determines the zero point for each row of the input matrix 127 by selecting the minimum value for each row. Thus, in the example shown in FIG. 1C, the zero point 130 values can be represented as X_{min, i}={−16.9, −202.1, 19}, where i represents the row of matrix and each row is associated with a particular channel. The quantization framework instead determines the zero point values can be represented as X_{min, j}, where j represents the column where each column is associated with a particular channel rather than each row.

The quantization framework determines a quantized value for each of the elements of the input matrix 115 using the equation (4) shown below:

$${X}_{q , ik} = round ( \frac{{X}_{ik} * {ZP}_{i}}{s} ) \qquad ( 4 )$$

where X_{q,ij} represents the quantized value in row i and column j of the quantized matrix X_{q} (shown as quantized matrix 133 in FIG. 1C), the round function rounds the floating point value to the nearest integer value, Xᵢⱼ represents the floating point value in row i and column j of the input matrix 115, ZPᵢ represents the zero point value for the row of the input matrix 127 of the value being quantized, and s represents the scaling factor. The quantized matrix 113 can be provided as an input to one or more components of an attention mechanism of an AI model to enable the model to perform inference on quantized data. Equation 4 is applied in implementations in which the input matrix 115 is oriented such that each row is associated with different channel of input data. In implementations in the input matrix 115 is oriented such that each column is associated with a different channel of the input data, the quantization framework utilizes equation (5) shown below instead of equation (4):

$${X}_{q , ik} = round ( \frac{{X}_{ik} * {ZP}_{k}}{s} ) \qquad ( 5 )$$

where X_{q,ij} represents the quantized value in row i and column j of the quantized matrix X_{q} (shown as quantized matrix 133 in FIG. 1C), the round function rounds the floating point value to the nearest integer value, Xᵢⱼ represents the floating point value in row i and column j of the input matrix 115, ZPₖ represents the zero point value for the column of the input matrix 127 of the value being quantized, and s represents the scaling factor. An example 111 of the quantization for one of the elements of the input matrix 115 is shown in FIG. 1B. The quantized matrix 113 provides an example in which all of the values of the input matrix 115 have been quantized according to equation (4).

The quantization framework determines a dequantized value for each of the elements of a quantized matrix, such as but not limited to the quantized matrix 133, using the equation (6) below:

dXᵢₖ=(qXᵢₖ×s)+ZPᵢ (6)

where qXᵢₖ represents the quantized value in row i and column k of the quantized matrix X_{q} (shown as quantized matrix 133 in FIG. 1C), dXᵢₖ represents the floating point value in row i and column k of the dequantized matrix X_{d} (shown as dequantized matrix 134 in FIG. 1C), ZPᵢ represents the zero point value for row of data being dequantized, and s represents the scaling factor. As can be seen in FIG. 1C, the values of the dequantized matrix 134 do not exactly match those of the input matrix 127 due to the loss in precision resulting from converting the values from the input matrix 127 from the FP32 data format to the quantized INT8 values of the quantized matrix 133. However, in the approach shown in FIG. In implementations in the quantized matrix 133 is oriented such that each column is associated with a different channel of the input data, the quantization framework utilizes equation (7) shown below instead of equation (6):

dXᵢₖ(qXᵢₖ×s)+ZPₖ (7)

where qXᵢₖ represents the quantized value in row i and column k of the quantized matrix X_{q} (shown as quantized matrix 133 in FIG. 1C), dXᵢₖ represents the floating point value in row i and column k of the dequantized matrix X_{d} (shown as dequantized matrix 134 in FIG. 1C), ZPₖ represents the zero point value for the column being dequantized, and s represents the scaling factor. An example 112 of the dequantization for one of the elements of the quantized matrix 113 is shown in FIG. 1B. The dequantized matrix 114 provides an example in which all of the values of the quantized matrix 113 have been quantized according to equation (6).

In the example shown in FIG. 1C, the zero point values for each of the rows of the quantized matrix 133 have been added to each of the rows of the quantized matrix 133 to facilitate later dequantization by the quantization framework. In other implementations, the scale factor may also be added to one or more of the rows of the quantized matrix 133 to facilitate later dequantization by the quantization framework.

FIG. 1D is a diagram providing a comparison of a matrix multiplication operation that is performed using the conventional zero point approach that utilizes a single zero point for each of the input matrices. The diagram contrasts this approach with an example of a matrix multiplication operation performed according to the quantization techniques provided herein.

The conventional approach 198 can be implemented using equation (8) below:

$${\sum }_{k} {a}_{ik} {b}_{kj} = {s}_{a} \cdot {s}_{b} {\sum }_{k} {qa}_{ik} \cdot {qb}_{kj} + {s}_{a} \cdot {m}_{b} {\sum }_{k} {qa}_{ik} + {s}_{b} \cdot {m}_{a} {\sum }_{k} {qb}_{kj} + {\sum }_{k} {m}_{a} \cdot {m}_{b} \qquad ( 8 )$$

where a is a first input matrix to be quantized, the matrix a having i rows and k columns, b is a second input matrix to be quantized, the matrix b having k rows and j columns, sₐ represents the scale factor for matrix a, s_{b} represents the scale factor for matrix b, mₐ represents the single zero point for the matrix a, and m_{b} represents the single zero point for the matrix b, qa represents the quantized version of matrix a, and qb represents the quantized version of matrix b.

A technical problem associated with the approach 198 shown above is that this approach can lead to performance degradation within the AI model. This degradation occurs primarily due to the use of a shared zero point across all channels, which can result in a loss of precision in critical areas of the AI model. Fine-grained group quantization methods attempt to mitigate this issue by allowing different zero points and scales for each group of channels. However, these methods typically require decompression before inference, which adds to complexity and latency to the AI model.

The shift quantized approach disclosed herein addresses these and other technical problems. The shift quantized approach 199 can be implemented using equation (9) below:

$${\sum }_{k} {a}_{ik} {b}_{kj} = {s}_{a} \cdot {s}_{b} {\sum }_{k} {qa}_{ik} \cdot {qb}_{kj} + {s}_{a} {\sum }_{k} {qa}_{ik} \cdot {m}_{kb} + {s}_{b} {\sum }_{k} {qb}_{kj} \cdot {m}_{ak} + {\sum }_{k} {m}_{a} \cdot {m}_{b} \qquad ( 9 )$$

where a is a first input matrix to be quantized, the matrix a having i rows and k columns, b is a second input matrix to be quantized, the matrix b having k rows and j columns, sₐ represents the scale factor for matrix a, s_{b} represents the scale factor for matrix b, mₐₖ represents the zero point for the kth row of matrix a, and m kb represents the zero point for the kth column of the matrix b, qa represents the quantized version of matrix a, and qb represents the quantized version of matrix b.

The approach shown in equation (9) allows for different zero points in different channel groups without the need for any dequantization step. A technical benefit of this approach is that the performance of the AI model that implements this approach benefits from the efficiency gains associated with operating in a quantized state. The ability to bypass decompression not only simplifies the inference process but also contributes to a significant reduction in memory usage and computation bandwidth. The three final terms of equation (9) implement matrix-vector multiplication rather than the element-wise multiplication utilized for the three final terms of equation (8). A technical benefit of this approach is that the shifted quantization technique shown in equation (9) does not increase computational steps and adds only a negligible increase in the memory utilized. The negligible memory increase associated with the approach shifted quantization approach provides a significant reduction in latency by avoiding the need for dequantization prior to inference as in the current approaches to quantization.

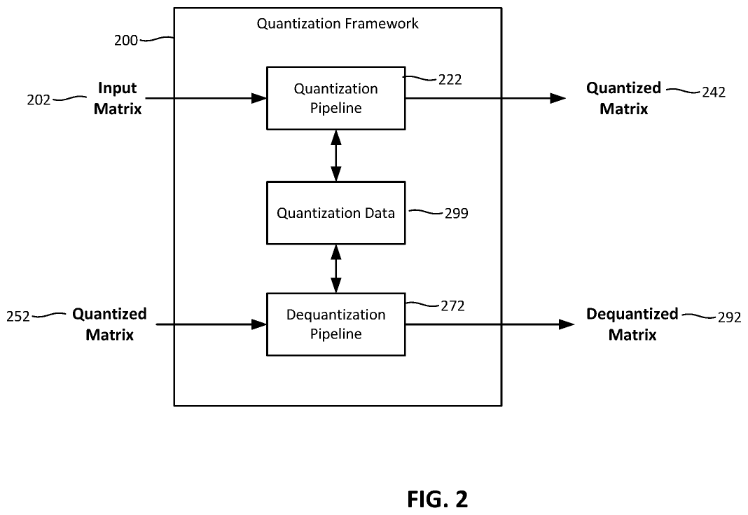

FIG. 2 is a diagram of an example implementation of the quantization framework 200. The quantization framework can be implemented by an attention mechanism of an AI model or other components of an AI model in some implementations.

The quantization framework receives an input matrix 202 to be quantized by converting the data in the input matrix 202 from a source data format to a target data format. In a non-limiting example, the source data format is the FP32 data format, and the target data format is the INT8 data format. The quantization framework 200 may be configured to support other source and target data formats. In some implementations, the quantization framework 200 s capable of supporting multiple source data formats and/or target data formats and the quantization framework receives an indication of the source data format and the target data format in addition to the input matrix 202. The quantization framework 200 can also receive an indication whether the matrix is oriented such that the rows or columns of the input matrix 202 represent separate channels. The input matrix 202, the indication of the source and target data formats, and the indication of the matrix orientation can be received from an attention mechanism of an AI model or other component of the AI model that utilizes the quantization framework to quantize data for the various calculation that are performed by the AI model. The input matrix 202 may be similar to the example input matrix 115 shown in FIG. 1B or the example input matrix 127 shown in FIG. 1B.

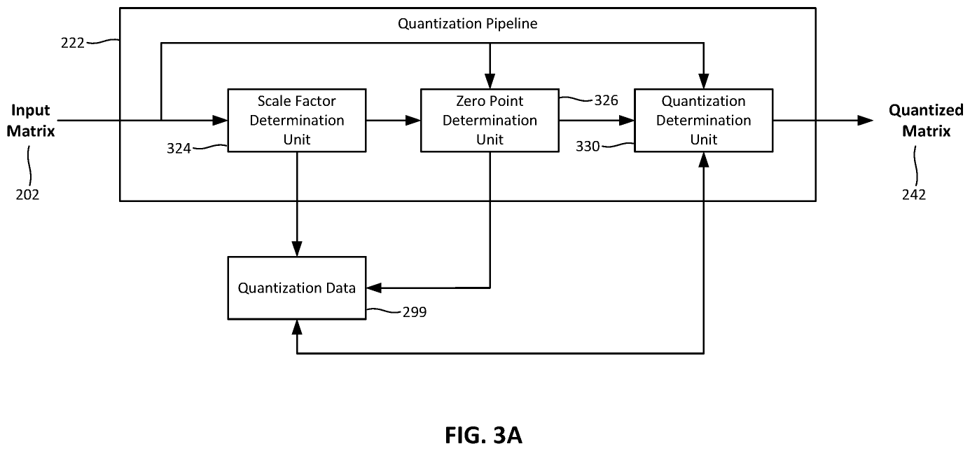

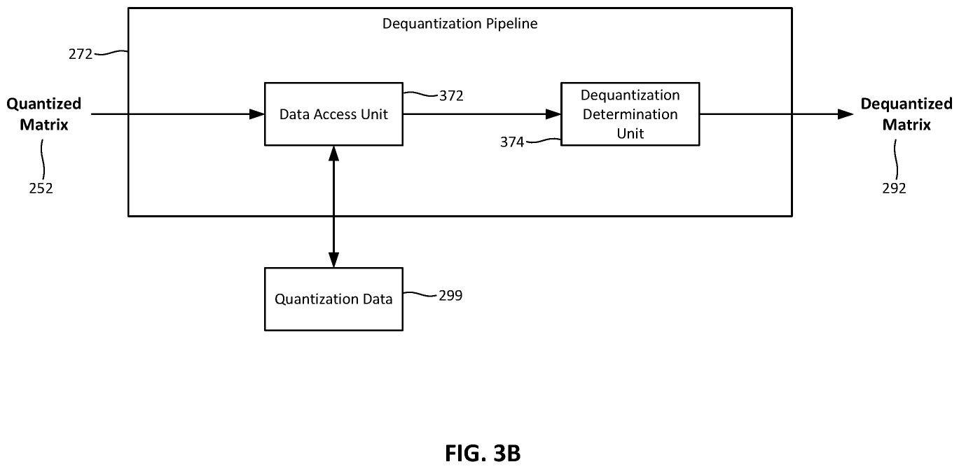

The quantization pipeline 222 receives the input matrix 202 as an input. The quantization pipeline 222 can also receive the indication of the source data format and/or the target data format as an input and/or the indication of the orientation of the input matrix 202 where such indications are utilized. The quantization pipeline 222 outputs a quantized matrix 242. The quantized matrix 242 may be similar to the quantized matrix 113 shown in FIG. 1B and the quantized matrix 133 shown in FIG. 1C. The quantization pipeline 222 generates quantization data 299, such as but not limited to the TRB, scale factor, and zero point values associated with the quantized matrix. The quantization data 299 can be stored in a memory allocated to the attention mechanism of the AI model. The quantization data 299 can be used by the dequantization pipeline 272 to dequantize the quantized matrix 242. In other implementations, the zero point values and/or the scale factors may be added to each row of the quantized matrix 242 as shown in FIG. 1C. FIG. 3A, discussed in detail below, provides an example implementation of the quantization pipeline 222.

The quantization framework 200 can also receive a quantized matrix 252 to be dequantized. The quantized matrix 252 represents a matrix that was quantized by the quantization pipeline 222. The dequantization pipeline 272 dequantizes the quantized matrix 252 using the quantization data 299 to generate the dequantized matrix 292. FIG. 3B, discussed in detail below, provides an example implementation of the dequantization pipeline 272.

FIG. 3A is a diagram of an example implementation of the quantization pipeline 222 of the quantization framework 200. The quantization pipeline 222 receives the input matrix 202 as an input. The input matrix 202 includes floating point values that are to be quantized from a source data format to a target data format. The quantization pipeline 222 can also receive an indication of the orientation of the input matrix 202. The indication of the orientation of the input matrix indicates whether the rows or the columns of the input matrix are associated with separate channels of data. The quantization pipeline 222 can also receive an indication of the source data format and the target data format in some implementations. In such implementations, the quantization pipeline 222 is capable of converting data from more than one source data format and/or converting data to one or more target data formats. The specific target data formats and/or source data formats supported by the quantization pipeline 222 may vary in different implementations.

The scale factor determination unit 324 determines a single scale factor for the entire input matrix 202. The scale factor determination unit 324 determines the scale factor for the input matrix 202 according to equation (1) discussed above. The scale factor is used to reformat each of the values of the input matrix from the source data format to the less precise target data format. The scale factor determination unit 324 adds the scale factor to the quantization data 299 associated with the input matrix 202 in some implementations.

The zero point determination unit 326 determines a zero point for each row or column based on the orientation of the input matrix 202. The scale factor determination unit 324 receives the indication of the orientation of the input matrix 202 from the scale factor determination unit 324. The zero point determination unit 326 determines the zero point values by selecting the minimum value in each respective row or column depending upon the orientation of the input matrix 202 according to the techniques discussed above. The zero point determination unit 326 stores the zero point values for the input matrix in the quantization data 299 in some implementations.

The quantization determination unit 330 generates the quantized matrix 242 based on the input matrix 202, the scale factor determined by the scale factor determination unit 324, and the zero point values determined by the zero point determination unit 326. The quantization determination unit 330 generates the quantized matrix 242 using equation (4) shown above where the input matrix 202 is oriented where each row is associated with a different channel. The quantization determination unit 330 generates the quantized matrix 242 using equation (5) shown above where the input matrix 202 is oriented where each column is associated with a different channel. In some implementations, the quantization determination unit 330 adds the zero point values for each row or column to that row or column of the quantized matrix 242 to facilitate later dequantization of the quantized matrix 242. The quantization determination unit 330 can also add the scale factor to at least one column or row of the quantized matrix 242 to facilitate dequantization.

FIG. 3B is a diagram of an example implementation of the dequantization pipeline 272 of the quantization framework 200. The dequantization pipeline 272 receives a quantized matrix 252 that includes quantized data to be converted back to a dequantized format. The quantized matrix 252. The dequantization framework provides the quantized matrix 252 as an input to the data access unit 372. The data access unit 372 obtains the scale factor and the zero point values used to quantize the data in the quantized matrix 252. The scale factor and/or the zero point values are stored in the quantized matrix 252 in some implementations, and the data access unit 372 extracts the scale factor and/or the zero point values from the quantized matrix 252. In other implementations, the scale factor and/or the zero point values are stored in the quantization data 299, and the data access unit 372 obtains the scale factor and/or the zero point values from the quantization data 299. The data access unit 372 provides the quantized matrix 252, the scale factor, and the zero point values are provided as an input to the dequantization determination unit 374. The dequantization determination unit 374 generates the dequantized matrix 292 using equation (6) shown above where the quantized matrix 252 is oriented where each row is associated with a different channel. The dequantization determination unit 374 generates the dequantized matrix 292 using equation (7) shown above where the quantized matrix 252 is oriented where each column is associated with a different channel.

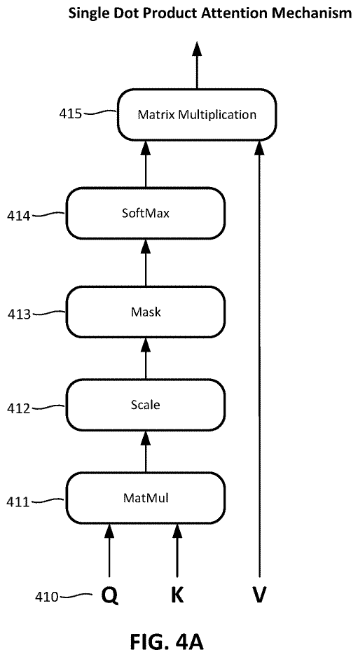

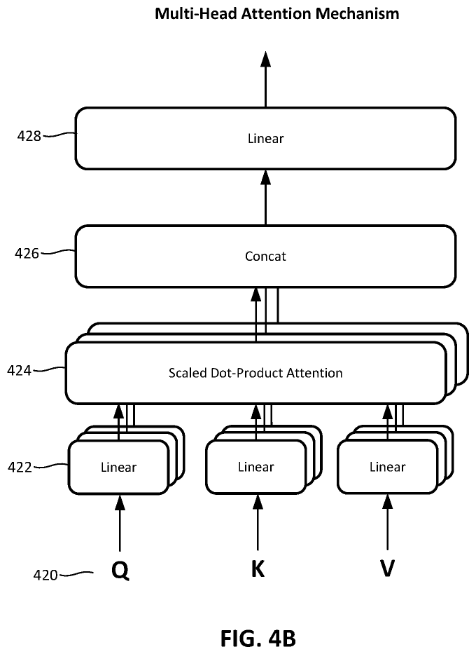

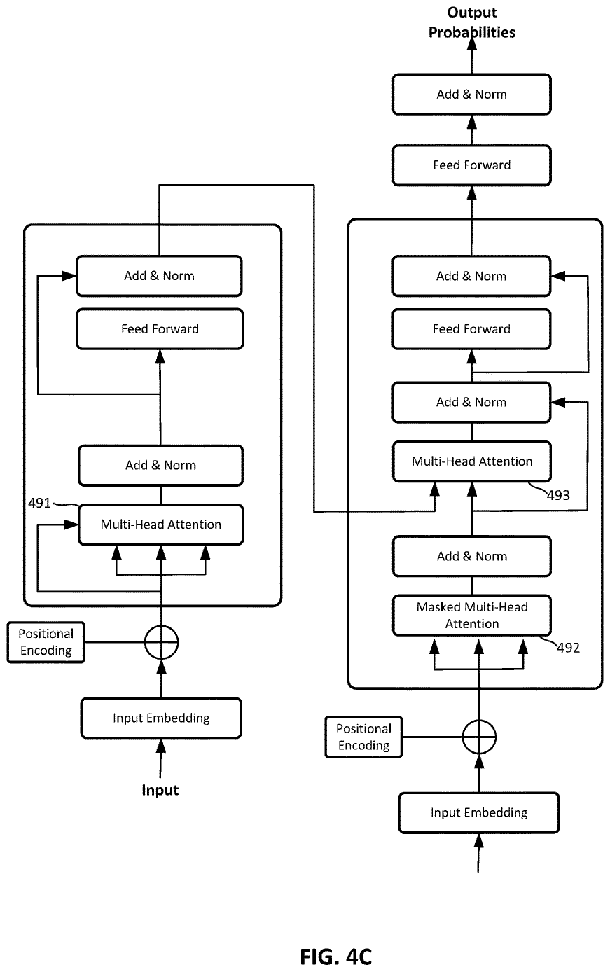

FIGS. 4A-4C are diagrams that provide examples of various types of attention mechanisms in which the quantization framework 200 provided herein could be used to generate quantized data to reduce the latency and computing resources associated with implementing such attention mechanisms. The examples shown in FIGS. 4A-4C are non-limiting and non-exhaustive. The quantization framework 200 can be utilized in other attention mechanism architectures.

FIG. 4A is a diagram of an example of a single dot product attention mechanism that can utilize the quantization framework 200 disclosed herein. The single dot product attention mechanism receives inputs 410, which include a query matrix (Q), a key matrix (K), and a value matrix (V). The quantization framework 200 can be used to quantize the query matrix, key matrix, and the value matrix using the techniques discussed in the preceding examples to facilitate quantization of the attention mechanism.

The matrix multiplication unit 411 multiplies the query matrix and the value matrix to generate a raw attention weight matrix. The raw attention weight matrix output by the matrix multiplication unit 411 is provided as an input to the scaling unit 412. The scaling unit 412 applies a scaling factor to the raw attention weights to ensure that the attention weights do not exceed an upper or lower threshold. The output from the scaling unit 412 is optionally provided to a masking unit 413 or to the softmax unit 414 where masking unit 413 is not included. The masking unit 413 utilizes a binary tensor that signals which tokens should be considered with non-zero weights and which tokens should be ignored with a zero weight. The masks are used to ensure that the AI model focuses on meaningful information. The softmax unit 414 receives the raw attention weight matrix as an input and outputs a normalized attention weight matrix as an output. The normalized attention weight matrix and the value matrix are provided as inputs to the matrix multiplication unit 415, and the matrix multiplication unit 415 outputs a matrix that is the weighted sum of the value vectors comprising the value matrix. The weights are determined by the normalized attention scores included in the normalized attention score matrix output by the softmax unit 414. Quantizing the query matrix, key matrix, and the value matrix using the quantization framework 200 shown in FIG. 2 enables the attention mechanism to be implemented using the faster low-precision tensor cores to perform the exponentiation operations associated with the softmax operation. Consequently, the performance of the AI model utilizing the attention mechanism can be significantly improved by reducing latency associated with the attention mechanism.

FIG. 4B is a diagram of an example of a multi-head attention (MHA) mechanism that can utilize the quantization framework 200 disclosed herein. MHA is a core component of the transformer architecture. An example of the transformer architecture is shown in FIG. 4C. The transformer architecture includes L stacked layers, and each layer includes an MHA mechanism and a feed-forward network (FFN). Given input token embeddings X∈ [symbol] ^{n×d}, the MHA computes attention in parallel across H attention heads according to equation (8) below:

$$MHA ( X ) = Concat ( {H}^{( 1 )} , ... , {H}^{( H )} ) {W}_{o} , \qquad ( 8 )$$

$${H}^{( h )} = soft max ( \frac{{Q}^{( h )} {K}^{( h ) T}}{\sqrt{{d}_{H}}} ) {v}^{( H )}$$

where Q^{(h)}=XW_{qh}, K^{(h)}=XWₖₕ, V^{(h)}=XWᵥₕ are the Query, Key, and Value matrices for head h. The projection matrices W_{qh}, Wₖₕ, Wᵥₕ∈ [symbol] ^{n×d} map the input embedding X to the respective attention components, and d_{H} is typically set to H to balance the dimensionality across heads.

The multi-head attention mechanism shown in FIG. 4B builds upon the single dot product attention mechanism shown in FIG. 4A. The multi-head attention mechanism receives Q, K, and V inputs 420, which include a query matrix, a key matrix, and a value matrix as inputs, which are similar to the inputs 410 of the single dot product attention mechanism shown in FIG. 4A. However, in the multi-head attention mechanism the linear transformation unit 422 transforms the single set of Q, K, and V matrices into multiple sets of matrices referred to as heads. Each head is generated using different weight matrices to enable the attention mechanism to capture more diverse relationships and patterns in the data. The Q, K, and V matrices associated with each head are provided as separate inputs to the scaled dot product attention unit 424. Separate instances of the scaled dot product attention unit 424 may be implemented for each head. The scaled dot product attention unit 424 can be implemented using the architecture shown in FIG. 4A. The outputs from the attention units are concatenated by the concatenation unit 426 and a final weight matrix is applied by the linear transformation unit 428. The quantization framework 200 shown in FIG. 2 can be used to quantize the Q, K, and V matrices. As a result, the performance of the AI model utilizing the attention mechanism can be significantly improved by reducing latency and computational complexity of the computations performed by the attention mechanism.

FIG. 4C is an example architecture of a transformer artificial intelligence model that can utilize the attention mechanisms that incorporate the softmax approximation framework disclosed herein. The example model architecture shown in FIG. 4C includes three attention mechanism units, unit 491, unit 492, and unit 493. Each of the attention mechanism units can utilize the quantization framework 200 shown in FIG. 2. The example shown in FIG. 4C is non-limiting and other implementations can utilize other models that include attention mechanisms that are implemented using the quantization framework 200 to improve the performance of the model.

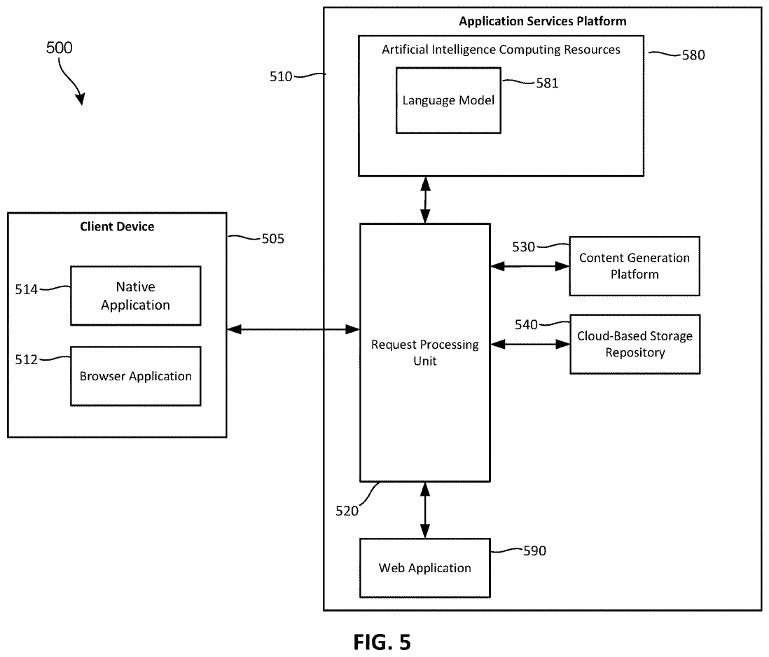

FIG. 5 is a diagram of an example computing environment 500 in which the quantization framework 200 is implemented. The example computing environment 500 includes a client device 505 and an application services platform 510. The application services platform 510 may provide one or more cloud-based applications and/or provides services to support one or more web-enabled native applications on the client device 505. These applications may include but are not limited to design applications, communications platforms, visualization tools, and collaboration tools for collaboratively creating visual representations of information, and other applications for consuming and/or creating electronic content. These applications can utilize one or more large language models (LLMs), such as the language model 581 to generate content for the applications. The language model 581 can implement one or more attention mechanism that utilize the quantization framework 200 shown in FIG. 2. The language model 581 can be implemented using a language model having transformer architecture. Other model architectures that utilize attention mechanisms can be utilized in other implementations. For instance, the language model 581 is not limited to a LLM. Other classes of models, such as but not limited to small language models (SLMs) may utilize the quantization techniques disclosed herein. The client device 505 and the application services platform 510 communicate with each other over a network (not shown). The network may be a combination of one or more public and/or private networks and may be implemented at least in part by the Internet.

The application services platform 510 can include a content generation platform 530. The content generation platform 530 provides tools that can be utilized by the native application 514 and/or the web application 590 to generate content utilizing the language model 581 and/or other AI models implemented by the application services platform 510. The content generation platform 530 is configured to construct prompts instructing the language model 581 and/or other AI models to generate specific content in response to requests from the native application 514 and/or the web application 590. The content generation platform 530 provides the requested content received from the model to the native application 514 and/or the web application 590.

The application services platform 510 may also include a cloud-based storage repository 540. The cloud-based storage repository may implement an AI-enabled search that utilizes an AI model implemented on the application services platform 510 that includes an attention mechanism that utilizes the quantization framework 200.

The request processing unit 520 receives requests from an application implemented by the native application 514 of the client device 505 and/or the web application 590 of the application services platform 510. The native application 514 and/or the web application 590 provide one or more user interfaces that enables users to view, create, and/or modify electronic content. The request processing unit 520 also coordinates communication and exchange of data among components of the application services platform 510.

The AI computing resources 580 provide a computing environment that allocates and operates computing resources for one or more AI models. These models can include the language model 581 and/or additional AI models that can be used to generate various types of content. The language model 581 and/or the other AI models can include an attention mechanism that implements the quantization framework 200 to reduce the computational and memory requirements of the attention mechanism and/or latency associated with the attention mechanism. Consequently, the performance of the language model 581 and/or the other AI models can be significantly increased without negatively impacting the performance of the language model 581 and/or the other AI models.

The client device 505 is a computing device that may be implemented as a portable electronic device, such as a mobile phone, a tablet computer, a laptop computer, a portable digital assistant device, a portable game console, and/or other such devices in some implementations. The client device 505 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 5 includes a single client device, other implementations may include a different number of client devices that utilize services provided by the application services platform 510.

The client device 505 includes a native application 514 and a browser application 512. The native application 514 is a web-enabled native application, in some implementations, that enables users to view, create, and/or modify electronic content. The web-enabled native application utilizes services provided by the application services platform 510 including but not limited to creating, viewing, and/or modifying various types of electronic content. In other implementations, the browser application 512 is used for accessing and viewing web-based content provided by the application services platform 510. In such implementations, the application services platform 510 implements one or more web applications, such as the web application 590, that enables users to view, create, and/or modify electronic content. The application services platform 510 supports both web-enabled native applications and a web application in some implementations, and the users may choose which approach best suits their needs.

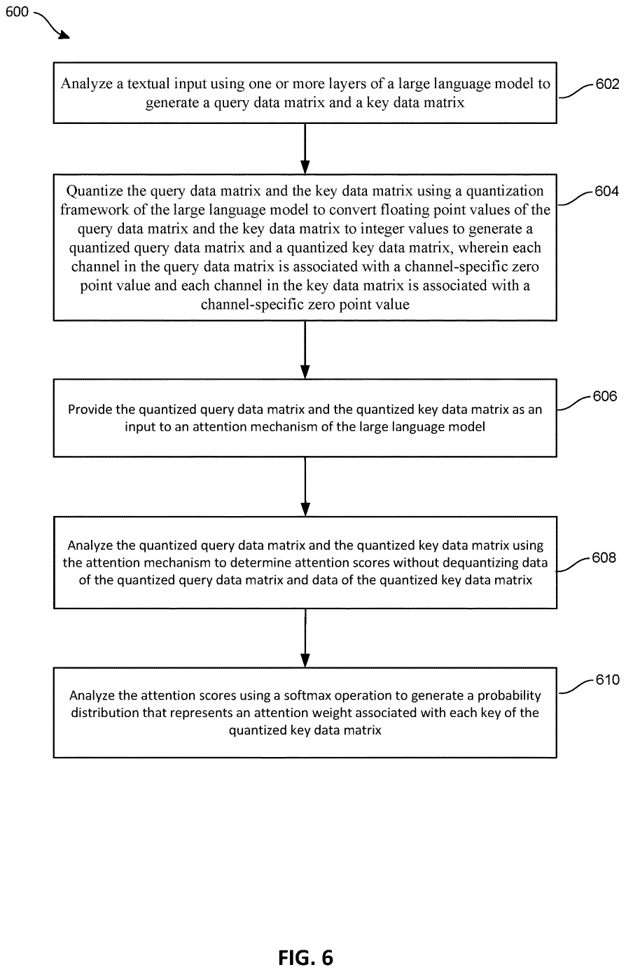

FIG. 6 is a flow chart of an example process 600 for quantizing data in an attention mechanism of an artificial intelligence model according to the techniques disclosed herein. The process 600 can be implemented, in part, by the quantization framework 200 shown in FIG. 2 and discussed in the preceding examples. The quantization framework 200 can be implemented by the attention mechanism of a language model and/or may be implemented as a separate component of the language model that enables the language model to utilize the quantization framework 200 to quantize data to be analyzed by various components of the language model.

The process 600 includes an operation 602 of analyzing a textual input using one or more layers of a large language model to generate a query data matrix and a key data matrix. The language model can receive an input or inputs and analyze these input or inputs using one or more layers that analyze the input and/or data derived therefrom to generate intermediate results. The language model is implemented by the language model 581 shown in FIG. 5 in some embodiments, while other implementations can implement the language model using a difference language model. The intermediate results may include query, key, and value matrices as discussed in the preceding examples, which are provided as an input to an attention mechanism, such as but not limited to the example attention mechanisms shown in FIGS. 4A and 4B. Each of these matrices can be quantized using the quantization framework 200 to facilitate the attention mechanism performing inference on quantized data. Furthermore, while FIG. 4C provides a non-limiting example of one language model architecture that implements attention mechanisms that can utilize the quantization framework 200 shown in FIG. 2, other implementations can utilize a different language model architecture that implements an attention mechanism that can utilize the quantization framework 200.

The process 600 includes an operation 604 of quantizing the query data matrix and the key data matrix using a quantization framework of the large language model to convert floating point values of the query data matrix and the key data matrix to integer values to generate a quantized query data matrix and a quantized key data matrix. Each channel in the query data matrix is associated with a channel-specific zero point value and each channel in the key data matrix is associated with a channel-specific zero point value. The quantization framework 200 quantizes the floating point values of the key data matrix and the query data matrix to enable the attention mechanism of the large language model to perform inference on the quantized data.

The process 600 includes an operation 606 of providing the quantized query data matrix and the quantized key data matrix as an input to an attention mechanism of the large language model and an operation 608 of analyzing the quantized query data matrix and the quantized key data matrix using the attention mechanism to determine attention scores without dequantizing data of the quantized query data matrix and data of the quantized key data matrix. The quantized data is analyzed by the attention mechanism of the language model. A technical benefit of this approach is that this approach efficiently handles outlier channels, which can significantly improve the performance of the attention mechanism in contrast with current quantization techniques which utilize a single zero point value for an entire input matrix.

The process 600 includes an operation 610 of analyzing the attention scores using a softmax operation to generate a probability distribution that represents an attention weight associated with each key of the quantized key data matrix. The attention mechanism of the language model The probability distribution output by the attention mechanism includes the attention weights generated by the attention mechanism and normalized by the softmax unit of the attention mechanism. The attention weights may be subjected to further processing by one or more additional layers of the language model. The specific processing that is performed is dependent at least in part on the architecture of the specific model.

The detailed examples of systems, devices, and techniques described in connection with FIGS. 1-6 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

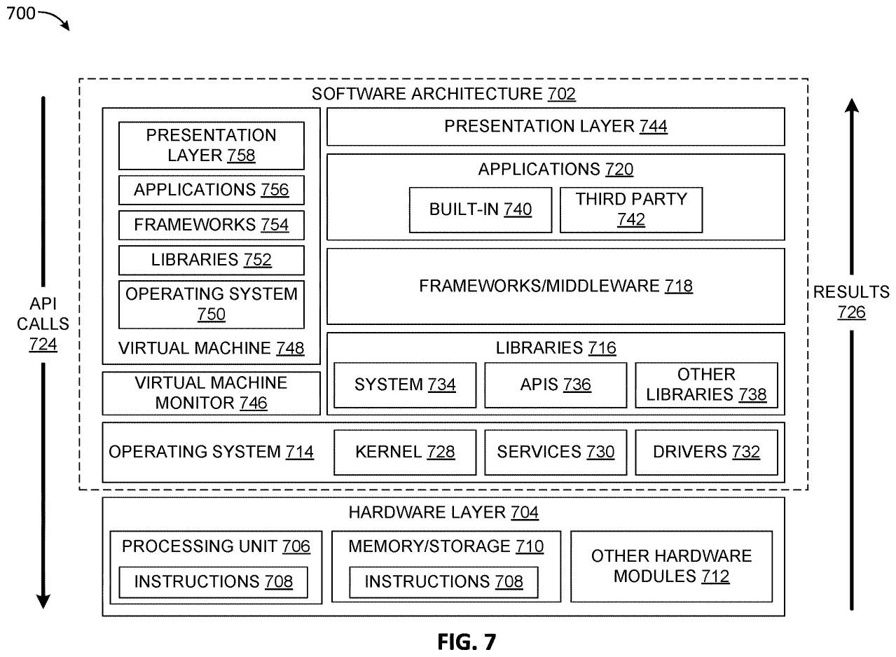

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory/storage, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks/middleware 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks/middleware 718 provide a higher-level common infrastructure that may be used by the applications 720 and/or other software modules. For example, the frameworks/middleware 718 may provide various graphic user interface (GUI) functions, high-level resource management, or high-level location services. The frameworks/middleware 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks/middleware 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory/storage 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multicore processor including cores that may execute instructions contemporaneously. Although FIG. 8 shows multiple processors, the machine 800 may include a single processor with a single core, a single processor with multiple cores (for example, a multicore processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirements of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
analyzing a textual input using one or more layers of a large language model to generate a query data matrix and a key data matrix;
quantizing the query data matrix and the key data matrix using a quantization framework of the large language model to convert floating point values of the query data matrix and the key data matrix to integer values to generate a quantized query data matrix and a quantized key data matrix, wherein each channel in the query data matrix is associated with a channel-specific zero point value and each channel in the key data matrix is associated with a channel-specific zero point value;
providing the quantized query data matrix and the quantized key data matrix as an input to an attention mechanism of the large language model;
analyzing the quantized query data matrix and the quantized key data matrix using the attention mechanism to determine attention scores without dequantizing data of the quantized query data matrix and data of the quantized key data matrix; and
analyzing the attention scores using a softmax operation to generate a probability distribution that represents an attention weight associated with each key of the quantized key data matrix.

2. The data processing system of claim 1, wherein each channel is associated with a respective row of the query data matrix, and wherein each channel is associated with a respective column of the key data matrix, and wherein to quantize the query data matrix and the key data matrix, the memory further stores executable instructions that, when executed, cause the processor alone or in combination with other processors to perform operations of:
determining, for each channel included in the query data matrix, the channel-specific zero point value by selecting a minimum value for each row of the query data matrix; and
determining, for each channel included in the key data matrix, the channel-specific zero point value by selecting a minimum value for each column of the key data matrix.

3. The data processing system of claim 2, wherein the memory further stores executable instructions that, when executed, cause the processor alone or in combination with other processors to perform operations of:
adding the channel-specific zero point value to the respective row of the query data matrix; and
adding the channel-specific zero point value to the respective column of the key data matrix.

4. The data processing system of claim 1, wherein each channel is associated with a respective column of the query data matrix, and wherein each channel is associated with a respective row of the key data matrix, and wherein to quantize the query data matrix and the key data matrix, the memory further stores executable instructions that, when executed, cause the processor alone or in combination with other processors to perform operations of:
determining, for each channel included in the query data matrix, the channel-specific zero point value by selecting a minimum value for each column of the query data matrix; and
determining, for each channel included in the key data matrix, the channel-specific zero point value by selecting a minimum value for each row of the key data matrix.

5. The data processing system of claim 4, wherein the memory further stores executable instructions that, when executed, cause the processor alone or in combination with other processors to perform operations of:
adding the channel-specific zero point value to the respective column of the query data matrix; and
adding the channel-specific zero point value to the respective row of the key data matrix.

6. The data processing system of claim 1, wherein to quantize the query data matrix and the key data matrix, the memory further stores executable instructions that, when executed, cause the processor alone or in combination with other processors to perform operations of:
determining a first scale factor for the query data matrix; and
determining a second scale factor for the key data matrix.

7. The data processing system of claim 6, wherein to determine the first scale factor for the query data matrix, the memory further stores executable instructions that, when executed, cause the processor alone or in combination with other processors to perform operations of:
determining target range bits (TRB) for values of the quantized query data matrix;
determining an absolute value of a maximum value (max) for the query data matrix; and
determining the first scale factor by
$$s = \frac{max}{{2}^{TRB - 1} - 2} ,$$
wherein s represents the first scale factor.

8. The data processing system of claim 6, wherein to determine the second scale factor for the key data matrix, the memory further stores executable instructions that, when executed, cause the processor alone or in combination with other processors to perform operations of:
determining target range bits (TRB) for values of the quantized key data matrix;
determining an absolute value of a maximum value (max) for the key data matrix; and
determining the second scale factor by
$$s = \frac{max}{{2}^{TRB - 1} - 2} ,$$
wherein s represents the first scale factor.

9. The data processing system of claim 6, wherein to analyze the quantized query data matrix and the quantized key data matrix to determine attention scores without dequantizing data of the quantized query data matrix and data of the quantized key data matrix, the memory further stores executable instructions that, when executed, cause the processor alone or in combination with other processors to perform operations of:
multiplying the query data matrix and the key data matrix using the first scale factor, the second scale factor, and the channel-specific zero point value for each channel to determine the attention scores without dequantizing the data of the quantized query data matrix and data of the quantized key data matrix.

10. The data processing system of claim 6, wherein the memory further stores executable instructions that, when executed, cause the processor alone or in combination with other processors to perform operations of:
quantizing the query data matrix where
$${qX}_{ik} = round ( \frac{{X}_{ik} * {ZP}_{i}}{s} ) ,$$
where qXᵢₖ refers to a quantized version of floating point value Xᵢₖ of the query data matrix at row i and column k, where ZPᵢ represents a zero point value for row i, and s represents the first scale factor for the query data matrix.

11. The data processing system of claim 6, wherein the memory further stores executable instructions that, when executed, cause the processor alone or in combination with other processors to perform operations of:
dequantizing the quantized query data matrix where dXᵢₖ=(qXᵢₖ×s)+ZPᵢ, where qXᵢₖ represents a quantized value in row i and column k of quantized matrix X_{q}, dXᵢₖ represents a floating point value in row i and column k of dequantized matrix X_{d}, ZPᵢ represents a zero point value for row of data being dequantized, and s represents the first scale factor.

12. A method implemented in a data processing system for quantizing data in an attention mechanism of an artificial intelligence model, the method comprising:
analyzing a textual input using one or more layers of a large language model to generate a query data matrix and a key data matrix;
quantizing the query data matrix and the key data matrix using a quantization framework of the large language model to convert floating point values of the query data matrix and the key data matrix to integer values to generate a quantized query data matrix and a quantized key data matrix, wherein each channel in the query data matrix is associated with a channel-specific zero point value and each channel in the key data matrix is associated with a channel-specific zero point value;
providing the quantized query data matrix and the quantized key data matrix as an input to an attention mechanism of the large language model;
analyzing the quantized query data matrix and the quantized key data matrix using the attention mechanism to determine attention scores without dequantizing data of the quantized query data matrix and data of the quantized key data matrix; and
analyzing the attention scores using a softmax operation to generate a probability distribution that represents an attention weight associated with each key of the quantized key data matrix.

13. The method of claim 12, wherein each channel is associated with a respective row of the query data matrix, and wherein each channel is associated with a respective column of the key data matrix, and wherein to quantize the query data matrix and the key data matrix, the method further comprising:
determining, for each channel included in the query data matrix, the channel-specific zero point value by selecting a minimum value for each row of the query data matrix; and
determining, for each channel included in the key data matrix, the channel-specific zero point value by selecting a minimum value for each column of the key data matrix.

14. The method of claim 13, further comprising:
adding the channel-specific zero point value to the respective row of the query data matrix; and
adding the channel-specific zero point value to the respective column of the key data matrix.

15. The method of claim 12, wherein each channel is associated with a respective column of the query data matrix, and wherein each channel is associated with a respective row of the key data matrix, and wherein quantizing the query data matrix and the key data matrix further comprises:
determining, for each channel included in the query data matrix, the channel-specific zero point value by selecting a minimum value for each column of the query data matrix; and
determining, for each channel included in the key data matrix, the channel-specific zero point value by selecting a minimum value for each row of the key data matrix.

16. The method of claim 15, further comprising:
adding the channel-specific zero point value to the respective column of the query data matrix; and
adding the channel-specific zero point value to the respective row of the key data matrix.

17. The method of claim 12, wherein quantizing the query data matrix and the key data matrix further comprises:
determining a first scale factor for the query data matrix; and
determining a second scale factor for the key data matrix.

18. The method of claim 17, wherein determining the first scale factor for the query data matrix further comprises:
determining target range bits (TRB) for values of the quantized query data matrix;
determining an absolute value of a maximum value (max) for the query data matrix; and
determining the first scale factor by
$$s = \frac{max}{{2}^{TRB - 1} - 2} ,$$
wherein s represents the first scale factor.

19. The method of claim 17, wherein determining the second scale factor for the key data matrix further comprises:
determining target range bits (TRB) for values of the quantized key data matrix;
determining an absolute value of a maximum value max) for the key data matrix; and
determining the second scale factor by
$$s = \frac{max}{{2}^{TRB - 1} - 2} ,$$
wherein s represents the first scale factor.

20. A machine-readable medium on which are stored instructions that, when executed, cause a processor of alone or in combination with other processors to perform operations of:
analyzing a textual input using one or more layers of a large language model to generate a query data matrix and a key data matrix;
quantizing the query data matrix and the key data matrix using a quantization framework of the large language model to convert floating point values of the query data matrix and the key data matrix to integer values to generate a quantized query data matrix and a quantized key data matrix, wherein each channel in the query data matrix is associated with a channel-specific zero point value and each channel in the key data matrix is associated with a channel-specific zero point value;
providing the quantized query data matrix and the quantized key data matrix as an input to an attention mechanism of the large language model;
analyzing the quantized query data matrix and the quantized key data matrix using the attention mechanism to determine attention scores without dequantizing data of the quantized query data matrix and data of the quantized key data matrix; and
analyzing the attention scores using a softmax operation to generate a probability distribution that represents an attention weight associated with each key of the quantized key data matrix.
